(19) United States
(12) Patent Application Publication
(10) Pub. No.: US 2025/0285606 A1
(43) Pub. Date: Sep. 11, 2025

(54) Volume And Tone Adjusting Pad For A Guitar

(71) Applicants: Justin Motander Jones, San Diego, CA (US); Scott Goodman Jones, San Diego, CA (US)

(72) Inventors: Justin Motander Jones, San Diego, CA (US); Scott Goodman Jones, San Diego, CA (US)

(21) Appl. No.: 19/074,257

(22) Filed: Mar. 7, 2025

Related U.S. Application Data
(60) Provisional application No. 63/562,421, filed on Mar. 7, 2024.

(51) Int. Cl. G10H 1/34; G10H 3/18

(52) U.S. Cl. CPC G10H 1/342; G10H 3/186; G10H 2220/465

(57) ABSTRACT

A touch-sensitive or pressure-sensitive pad located near the bridge of a guitar allows a guitarist to adjust tone, adjust volume, or blend in an additional pickup with his or her palm without removing his or her hand away from the strings. To operate the pad, the guitarist presses on the pad, varying the pressure according to the degree of adjustment to tone or volume desired. A switch on the guitar's control plate allows for selection of the desired effect of pressing on the touch pad.

### RELATED APPLICATIONS

This application claims priority to U.S. Provisional Patent Application Ser. No. 63/562,421 for “Volume and Tone Adjusting Pad for a Guitar,” filed Mar. 7, 2024, and currently co-pending, the entirety of which is incorporated herein by reference.

### FIELD OF THE INVENTION

The present invention pertains generally to user-interactive signal processing. More particularly, the present invention provides sound modification capabilities to an electronic instrument. The present invention is particularly, but not exclusively, useful as a tone and volume adjuster for an electric guitar.

### BACKGROUND OF THE INVENTION

The electric guitar, introduced in the 1930s, has become one of the most dominant instruments in modern pop, rock, jazz, and country music. Solid-body electric guitars, such as the iconic Fender Stratocaster, use magnet-in-coil transducers referred to as “pickups” to turn the vibration of the strings into an electrical signal that can be amplified and used to drive a speaker.

Many electric guitars have controls for adjusting the output signal, and therefore the resultant sound from the speaker. These controls often include volume and tone dials on the guitar's body. Guitars that use more than one pickup may have a pickup selector switch on the body to select one or more of the pickups to be used for the output signal. A vibrato bar or whammy bar on some guitars moves the bridge to change the tension of the strings, resulting in a “pitch bend” effect through temporary change in pitch of the sound produced.

The volume, tone, and other controls on a guitar body are meant to be within reach of the guitarist's hand while playing, but have to be placed where they won't be disturbed accidentally. Thus, a guitarist has to move his or her hand away from the strings to make changes, which can momentarily interrupt playing.

In view of the above, it would be advantageous to provide a way for a guitarist to adjust tone and volume without moving his or her hand away from the strings. It would be further advantageous to provide those tone and volume adjustment capabilities in a manner in which they are unlikely to be accidentally engaged. It would be further advantageous for controls to function rapidly, and with minimal movement. allowing them to me used for rhythmic and percussive accents to music being played.

### SUMMARY OF THE INVENTION

Disclosed is a volume and tone adjusting pad for an electric guitar. Preferred embodiments provide a touch-sensitive or pressure-sensitive pad near the bridge of the guitar and allow a guitarist to select or blend in a pickup and adjust tone and volume with his or her palm without removing his or her hand away from the strings. Pressure sensitivity allows for large changes in volume and tone to be produced with smaller movements than traditional controls.

To operate the pad, the guitarist uses small movements of the wrist or palm to create pressure on an appropriate part of the pad, depending on the result the guitarist desires. In a preferred embodiment, the desired function is selected with a switch before pressing on the pad. In an alternative embodiment, the function is selected by the location pressed on the pad; for example, pressing down on one portion of the pad results in a change to volume, while pressing another portion changes tone, and another portion selects which pickup is used to provide output from the strings.

Preferred embodiments of the volume and tone adjusting pad work by integrating into the circuit of the guitar to provide the selected effect when the pad is depressed. The manner of adjusting the tone and volume settings, as well as selecting which pickups provide the signal to the volume and tone adjusting pad, differs from that of the electric guitar as discussed above: Through palm gestures the user places pressure on portions of the pad without moving the hand away from the strings. In this way, changes can be made without interruptions in playing the guitar.

An alternative embodiment receives and processes the signal from the output jack of the guitar with no direct integration into the circuitry of the guitar. This works in a similar manner to the circuitry of the electric guitar itself: The volume and tone adjusting pad receives an electrical signal representing sound from one or more pickups of the guitar, process the signal using variable resistance, capacitors, inductors, or a combination thereof according to tone and volume settings, and output the processed signal to an amplifier or other devices, such as foot pedals, for further processing.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 illustrates an electric guitar with a preferred embodiment of a volume and tone pad;

FIG. 2 is a schematic diagram of major components an electric guitar, showing a guitar with two pickups;

FIG. 3 is a schematic diagram of major components an electric guitar, showing a guitar with three pickups;

FIG. 4 is a schematic diagram of the connections of a preferred embodiment of a volume and tone pad to an electric guitar for volume control;

FIG. 5 is a schematic diagram of the connections of a preferred embodiment of a volume and tone pad to an electric guitar for a filter effect;

FIG. 6 is a schematic diagram of the connections of a preferred embodiment of a volume and tone pad to an electric guitar for a blend effect between two pickups;

FIG. 7 is a schematic diagram of the connections of a preferred embodiment of a volume and tone pad to an electric guitar for blending in a third pickup; and

FIG. 8 is a schematic diagram of a preferred embodiment of a volume and tone pad connected to an external output jack;

### DETAILED DESCRIPTION

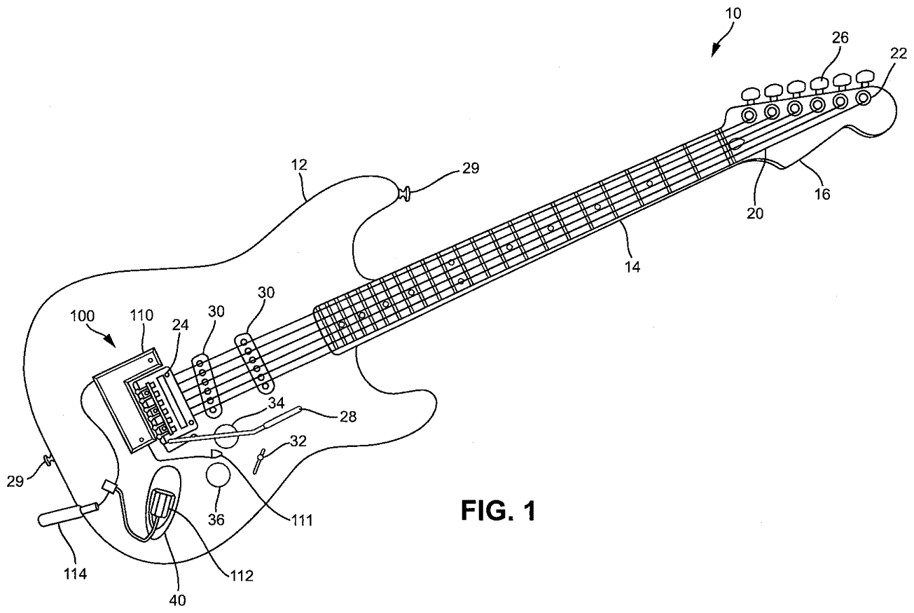

Referring initially to FIG. 1, a preferred embodiment of a volume and tone pad 100 is illustrated on a typical electric guitar 10. Guitar 10 has a body 12, neck 14, and headstock 16. The general shape of these components, and especially body 12 and headstock 16, varies between types of electric guitar 10. Volume and tone pad 100 is suitable for use with a great variety of types of electric guitar 10. Strings 20 are held taut between tuning posts 22 on headstock 16 and bridge 24 on body 12. Tuning keys 26 allow for adjustment of the tension of strings 20. By turning a tuning key 26, the associated string 20 is tightened or loosened, thereby raising or lowering, respectively, the pitch produced by the string 20 when strummed. Vibrato bar 28, also referred to as a “whammy bar,” can be engaged to move the bridge 24, altering the tension of strings 20 to momentarily change the pitch produced by strings 20. Strap buttons 29 allow a strap (not shown) to be attached to electric guitar 10.

One or more magnetic pickups 30 use a magnet within a coil to generate an electric current from the vibration of strings 20. Pickups 30 are in electrical communication, through pickup selector switch 32, with volume control 34 and tone controls 36, which adjust the signal provided to output 40. The number of pickups 30 and tone controls 36 tend to vary between different types and models of electric guitars 10, as does the presence of a vibrato bar 28. In many models, vibrato bar 28 is removable. Additional controls, such as blend controls to adjust the ratio of signals being mixed between multiple pickups 30, are present on some electric guitars 10.

A preferred embodiment of tone and volume pad 100 has a touch sensor 110 with an ‘L’ shape to facilitate placement along the left side and bottom of bridge 24, considering the portion of bridge 24 nearest to neck 14 as the top. Placement of touch sensor 110 is illustrated in a typical configuration, with its upper portion along the side of bridge 24 closest to the lowest-pitched string 20, which is the ‘E’ string on a standard guitar using standard tuning. Other designs and arrangements of touch sensor 110 are fully contemplated, including an embodiment laid out for placement on the bottom and right side of bridge 24, which is particularly suitable for left-handed guitars.

Touch sensor 110 is pressure-sensitive and when pressed by a guitarist, alters the tone or volume of the sound output by electric guitar 10, depending on where pressed and the amount of pressure applied, or setting of an effect mode switch 111. The position of touch sensor 110 allows for a guitarist to press it with the guitarist's palm without moving the guitarist's hand away from strings 20. This allows the guitarist to make adjustments to the sound while playing without having to remove the hand away from strings 20 to access controls such as volume control 34 and tone controls 36.

In preferred embodiments, tone and volume pad 100 is be integrated into the circuitry of electric guitar 10 so that output 40 provides the fully modified signal. However, an alternative embodiment is attachable to an electric guitar 10 without modification of its circuitry, and instead provides plug 112 which is inserted into output 40, through which tone and volume pad 100 obtains the output signal of electric guitar 10, modifies it, and provides the processed output through its own output jack 114, which can be connected to an amplifier or other equipment. Other preferred embodiments provide output jack 114 in addition to their interaction with the circuitry of electric guitar 10, as discussed below in connection with FIG. 10.

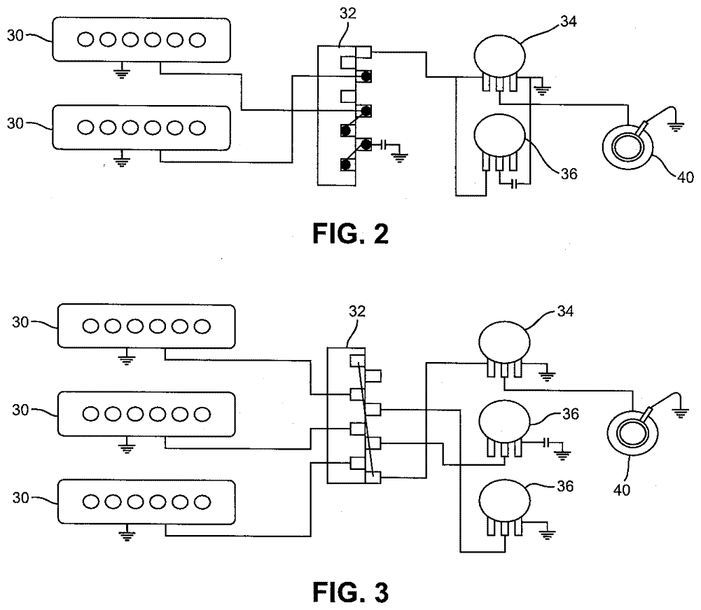

Referring now to FIG. 2, a schematic diagram of an electric guitar 10 is illustrated. In a typical electric guitar 10, pickup selector switch 32 provides the signal from one or more of pickups 30, depending on the position of switch 32, to volume control 34 and tone control 36. Volume control 34 and tone control 36 are typically implemented in the form of potentiometers, as illustrated, with a knob or dial attached for accessibility on guitar body 12 (shown in FIG. 1). As illustrated, tone controls 36 tend to be used as variable resistors while volume control 34 is used as a variable voltage divider. The electric guitar 10 provides the processed signal through output 40, typically implemented in the form of an audio jack.

Guitar 10 is shown with two pickups 30 and a single volume control, but it is common for a guitar to have different numbers of pickups 30. For example some electric guitars have a single pickup 30, while others have three or more pickups 30. Moreover, pickups 30 are available in different designs, such as humbucker pickups that have two coils instead of one, resulting in a different quality of sound.

Referring now to FIG. 3, an alternate schematic diagram of an electric guitar 10 is illustrated. This variant of guitar 10 functions similarly to the two-pickup variant described above, but has three pickups 30 and two tone controls 36. Switch 32 therefore has more options: At least a three-way switch is used in order to select one of the three pickups 30. However, a four-way or a five-way switch is common, allowing for two pickups 30 to be “blended,” that is, for their output to be combined. Some electric guitars further have a blend control (not illustrated), usually in the form of a potentiometer like volume control 34 and tone controls 36. A blend control allows the guitarist to adjust the relative amount of signal each of two blended pickups 30 provides to the final, processed signal provided to output 40.

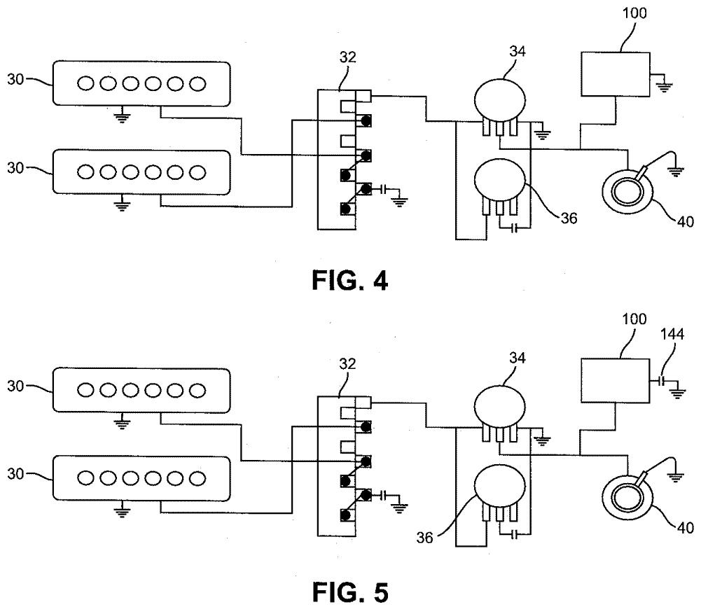

Referring now to FIG. 4-7, the manner of connection of tone and volume pad 100 to the circuitry of an electric guitar 10 for various effects is illustrated. In preferred embodiments, switch 111 (shown in FIG. 1) selects which of the effects is operational, and therefore which of the connections in FIGS. 4-7 is active. For simplicity and clarity in illustration, circuitry for a guitar 10 with two pickups 30 is illustrated in each of FIGS. 4-8 except for FIG. 7, but it will be apparent to a person of ordinary skill in the art that the same or similar adaptations can be made to guitars 10 with one, three, or any other number of pickups.

FIG. 4 illustrates tone and volume pad 100 connected to provide a volume effect. When this function is selected, pressing down on touch sensor 110 (shown in FIG. 1) will send a portion of the signal voltage to ground. The portion of the signal voltage sent to ground is proportional to the pressure applied to touch sensor 110, thus providing an adjustable control of volume the guitarist without the need to move the hand to the volume control 34 (shown in FIG. 1).

FIG. 5 shows a similar connection between tone and volume pad 100. However, when this function is selected, output is sent through a capacitor 144 to ground. As a result, when touch sensor 110 (shown in FIG. 1) is pressed, high frequency signal components are removed in proportion to the pressure applied, resulting in a tone effect. Some embodiments use an inductor in place of, or in addition to, capacitor 144 to provide different filter effects. Embodiments that allow the user to select between capacitor 144, an inductor, or an inductor-capacitor (LC) filter, whether through switch 111 or through another switch or selection mechanism, are fully contemplated herein.

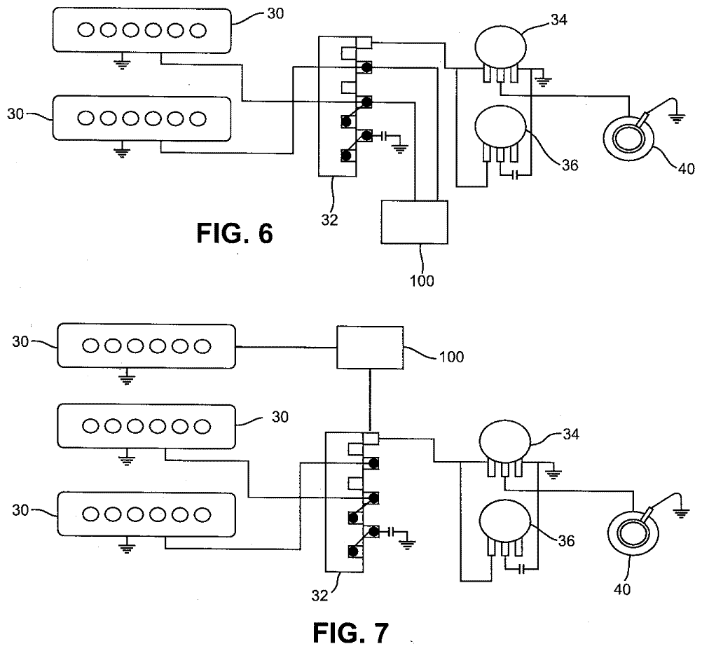

FIG. 6 shows tone and volume pad 100 wired across the output of pickups 30. This function is used when either of pickups 30 is selected via the controls of guitar 10 (shown in FIG. 1), but not both. When touch sensor 110 (shown in FIG. 1) is depressed, the signal of the other, unselected pickup 30 is blended in with the signal of the selected pickup 30 to provide a blend effect. As with the other effects, in a preferred embodiment the degree that the signal of the unselected pickup 30 is blended in is proportional to the pressure applied to touch sensor 110.

FIG. 7 shows tone and volume pad 100 wired for another blend function useful for electric guitars 10 with at least three pickups 30. This function is used when one or two of pickups 30 are selected, and blends in the third pickup 30 in proportion to the pressure applied to touch sensor 110 (shown in FIG. 1).

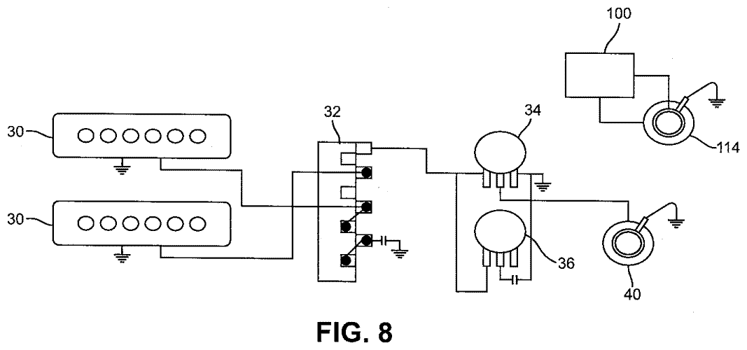

Referring now to FIG. 8, the circuitry of an electric guitar 10 is illustrated with an alternative preferred embodiment of tone and volume pad 100 that provides an additional output jack 114. Tone and volume pad 100 integrates into the circuitry of electric guitar 10 as illustrated in FIGS. 4-7 to provide the previously-described features. Additional output jack 114 provides the guitarist with the opportunity to connect additional equipment: For example, output jack 114 can be used as a control for external signal processing equipment. In one such embodiment, a function related to output jack 114 can be selected, for example with switch 111 (shown in FIG. 1), and the guitarist varies parameters sent to an external signal processor, such a guitar pedal, by pressing touch sensor 110. As with other functions, the parameter can be adjusted by varying the pressure applied to touch sensor 110.

In FIG. 8, two pickups 30 are shown for illustrative purposes, but tone and volume pad 100 can be used with electric guitars 10 with other numbers of pickups 30.

The additional output jack 114 is also used in another alternative embodiment of tone and volume pad 100 that connects to output jack 40 rather than directly interacting with the circuitry of electric guitar 10, and provides its processed output to output jack 114, which is connected to an amplifier or other equipment. This embodiment can provide tone and volume functions analogous to those described above by sending a portion of the signal to ground, or through a capacitor, inductor, or both, to ground in proportion to the pressure applied to touch sensor 110.

While there have been shown what are presently considered to be preferred embodiments of the present invention, it will be apparent to those skilled in the art that various changes and modifications can be made herein without departing from the scope and spirit of the invention.

What is claimed is:

1. A volume and tone adjusting pad, comprising:
a pad fixed on a body of an electric guitar, the pad configured to receive electrical signals from the electric guitar, process the electrical signals according to settings established by placing pressure on the pad, and provide the processed electrical signals to an audio output jack for a sound to be produced.

2. The volume and tone adjusting pad as recited in claim 1, wherein the electrical signals are processed according to the degree of pressure applied on the pad.

3. The volume and tone adjusting pad as recited in claim 2, further comprising a switch configured to select between predetermined processing functions.

4. The volume and tone adjusting pad as recited in claim 3, wherein the processed electrical signals adjust a volume level of the sound produced.

5. The volume and tone adjusting pad as recited in claim 3, wherein the processed electrical signals adjust a tone of the sound produced.

6. The volume and tone adjusting pad as recited in claim 4 or 5, wherein the switch is either a three way switch, a four way switch, or a five way switch.

7. A volume and tone adjusting pad, comprising:
a pad fixed on a body of an electric guitar, the pad configured to provide control signals to an external signal processor when pressure is placed on the pad, the control signal varying in relation to the amount of pressure placed on the pad.

8. The volume and tone adjusting pad of claim 7, wherein the external signal processor relays the control signal to an audio jack for a sound to be produced.

9. The volume and tone adjusting pad of claim 8, further comprising a switch configured to select between predetermined processing functions.

10. The volume and tone adjusting pad as recited in claim 9, wherein the processed electrical signals adjust a volume level of the sound produced.

11. The volume and tone adjusting pad as recited in claim 9, wherein the processed electrical signals adjust a tone of the sound produced.

12. The volume and tone adjusting pad as recited in claim 10 or 11, wherein the switch is either a three way switch, a four way switch, or a five way switch.
